(19) United States
(12) Patent Application Publication
(10) Pub. No.: US 2020/0095827 A1
(43) Pub. Date: Mar. 26, 2020

(54) LADDER SUPPORT

(71) Applicant: Dylan Skelhorn, Dlackmannanshire, Glasgow Centn (GB)

(72) Inventor: Dylan Skelborn, Clackmannanshire, Glasgow Central (GB)

(21) Appl. No.: 16/620,476

(22) PCT Filed: Jun. 6, 2018
(86) PCT No.: PCT/GB2018/051549

§ 371 Date: Dec. 6, 2019

(30) Foreign Application Priority Data
Jun. 7, 2017 (GB) 1709044.0

(51) Int. Cl. E06C 7/42; E06C 7/00

(52) U.S. Cl. CPC E06C 7/426; E06C 7/003

(57) ABSTRACT

The invention relates to a ladder stabiliser that obviates the existing requirement for a leaning ladder to be physically secured to a building and/or “footed” near the ground by a second person. The stabiliser comprises a base (12) for supporting, in use, both feet of a ladder (100); and upstanding walls (14, 16, 18, 20) defining an open-topped three-dimensional space for accommodating, and at least partially enclosing, the lower distal ends of a ladder (100) at a predetermined optimum angle of inclination. At least one wall (14, 16, 18, 20) extends above the height of the lowermost rung of an inclined ladder (100). A pivotable wall (18) is openable to allow the ladder (100) to be inserted and removed from the stabiliser. The stabiliser may be provided with removable ballast weights (30), and adjustable clamps (36).

The present invention relates to a ladder stabiliser and, particularly, but not exclusively, to a ladder stabiliser that obviates the existing requirement for a leaning ladder to be physically secured to a building and/or “footed” near the ground by a second person.

The use of ladders by employees is heavily regulated in the United Kingdom and governed by “The Work at Height Regulations 2005—Schedule 6 (Requirements for Ladders)”. According to the United Kingdom's Health and Safety Executive (HSE), not only are falls from ladders the leading category of “high fall” accidents, but they are also the primary source of fatalities. Guidance issued by the HSE states that ladders must be prevented from slipping during use by adopting one of the following options (presented in diminishing order of preference): (i) tying both stiles of the ladder to secure anchor points; (ii) using a ladder stability device; (iii) securely wedging the stiles of the ladder against a wall; and finally (iv) only if none of the foregoing is possible, “footing” of the ladder by a second person.

Whilst representing the preferred means of securing a ladder, option (i) above requires appropriate anchor points to be available or invasively installed, e.g. on a building facade, and so is often not desirable or practicable, particularly if—as is often the case—the job at hand requires regular movement of a ladder to a new position. As for option (ii), many existing stability devices provide only limited protection (as discussed further below) and require a degree of diligence on the part of the user for safe usage. Option (iii) is rarely available and, even when it is, it significantly constrains the placement of the feet of a ladder and its angle of inclination. For those reasons, the most commonly adopted option is footing of the ladder by a second person. However, human factors such as the tendency for a person to become distracted or complacent mean that this is an unreliable method of ensuring the safety of a person working at height.

Numerous forms of ladder stabilisers are already known which provide a simple base structure for engaging the feet of a ladder for the purpose of increasing surface area contact with the ground, and thereby reducing the likelihood of slippage. An example of such a stabiliser is disclosed in US patent publication No. US2009/0200110 (Donald Esselborn). However, stabilisers of this type are generally limited to preventing, or at least reducing, the tendency for the feet of a ladder to slip. They are generally ineffective in preventing the full range of unwanted ladder movements associated with “high fall” accidents. For example, lateral slippage of a ladder at its upper contact point, and flipping or pivoting of a ladder at its upper end each tend to cause one foot to disengage with the ground.

The present invention therefore seeks to provide an improved ladder stabiliser which addresses, or at least ameliorates, one or more of the aforementioned disadvantages by ensuring that a single person can safely use a ladder in all circumstances. In preferred embodiments, this is achieved whilst also satisfying existing legislative safety requirements.

According to the present invention, there is provided a ladder stabiliser comprising:
(i) a base for supporting, in use, both feet of a ladder; and
(ii) at least one wall extending upwards from the base and defining a first open-topped three-dimensional space for accommodating, and at least partially enclosing, the lower distal ends of a ladder;
   wherein at least part of said at least one wall extends to a height above the base which, in use, is equal to, or greater than, that of the lowermost rung of an inclined ladder.

It will be appreciated that an increased height of said at least one wall provides additional support to a ladder and reduces or eliminates unwanted movement of its lowermost distal ends. In a preferred embodiment, said at least one wall extends to a height above the base of at least 25 cm, this being the generally expected minimum spacing of ladder rungs. The first rung on a ladder will usually be located a distance of less than 25cm from the ladder feet and so this wall height will, in the vast majority of cases, exceed the height of the lowermost ladder rung.

Optionally, said first three-dimensional space is defined, at least in part, by substantially planar spaced apart side walls each extending upwards from the base.

Optionally, said first three-dimensional space is defined, at least in part, by a substantially planar first wall extending upwards from the base.

Optionally, the first wall extends between the spaced apart side walls.

Optionally, the first wall is inclined at an angle of inclination with respect to the base for providing support, in use, to the rear surfaces of ladder stiles located within the first three-dimensional space defined by the base, the first wall, and the side walls.

Optionally, the angle of inclination of the first wall relative to the base is between 75 degrees and 77 degrees.

Preferably, the angle of inclination of the first wall relative to the base is 75.96 degrees.

It will be appreciated that an angle of inclination of 75.96 degrees corresponds to the optimum “1 in 4” gradient rule whereby for every four units of height to be climbed, the base of the ladder moves one unit out.

Optionally, a pair of laterally adjustable clamps are arranged within the first three-dimensional space for selectively engaging, in use, respective outer lateral side surfaces of ladder stiles.

Preferably, the laterally adjustable clamps are attached to the respective opposing side walls of the first three-dimensional space.

It will be appreciated that the lateral forces applied to the respective outer lateral side surfaces of ladder stiles will resist sideways movement of the ladder within a general plane lying parallel to that of the inclined first wall.

Optionally, said first three-dimensional space is defined, at least in part, by a substantially planar second wall extending upwards from the base.

Optionally, the second wall is spaced from the first wall and extends between the spaced apart side walls.

Optionally, at least one of the respective side walls, the first wall and the second wall extends to a height above the base which is greater, in use, than that of the lowermost rung of an inclined ladder.

It will be appreciated the presence of the second wall will resist: (i) slippage of both ladder stiles in a direction away from the inclined first wall; and (ii) forward movement of a single ladder stile in a twisting movement away from general plane of the inclined first wall.

Optionally, the second wall has a hinged connection with the base and is moveable between an open and closed positions.

Alternatively, the second wall has a hinged connection with one of the side walls and is moveable between open and closed positions.

Optionally, a lock is provided for selectively securing the second wall in the closed position.

It will be appreciated that the open position of the second wall facilitates movement of a ladder into and out of the first three-dimensional space. When in the closed position, the second wall is inclined relative to the base, its angle of inclination being substantially equal to that of the first wall. The first and second walls and the side walls together delineate a rectangular shape in cross-section through a plane parallel to the base.

Optionally, a central recessed portion is formed in the first wall.

Optionally, the central recessed portion is provided with a base, opposing side walls and a rear wall.

Optionally, a central cut-out portion is provided on the second wall to generally coincide with the central recessed portion formed in the first wall.

It will be appreciated that the two lateral inclined faces of the first wall either side of the central recessed portion are arranged to coincide with the position of the spaced stiles of a ladder when it is located within the first three-dimensional space; and the central recessed portion is dimensioned to accommodate the part of a user's foot which, during use, extends beyond the lowermost rung of a ladder.

Optionally, a substantially planar third wall extends upwards from the base.

Optionally, the third wall is spaced from the first wall and extends between the spaced apart side walls.

Optionally, a second open-topped three-dimensional space is defined by the spaced apart first and third walls, and the spaced apart side walls.

Optionally, at least one removable ballast weight is receivable within the second three-dimensional space.

It will be appreciated that the cumulative weight of the ballast within the second three-dimensional space will be sufficient to anchor the ladder stabiliser and its associated ladder. The particular weight required to do so may vary dependent on various factors including the height of the ladder, the weight of the user and any materials being carried. Conveniently, the cumulative overall ballast weight may be distributed between multiple ballasts of lesser individual weight. An optimum weight for each individual ballast will be no more than 25 kg which is generally accepted as being the maximum safe weight to be carried manually by a male.

Optionally, height-adjustable feet are connected to the base and/or side walls for levelling the ladder stabiliser before use.

Optionally, the height-adjustable feet are located at fixed positions proximate each corner of the base and/or side walls.

Alternatively, the height-adjustable feet are provided on struts which are pivotably deployable away from each side wall.

Optionally, a fourth wall is spaced from the third wall and extends between the spaced apart side walls to define a third open-topped three-dimensional space.

The third open-topped three-dimensional space may be used as a storage space. By way of example only, the third open-topped three-dimensional space may be used to store collapsible fluorescent warning cones for placement around the ladder stabiliser during use.

Optionally, at least two spirit levels are provided on at least two of the respective side walls, the first wall, the second wall, the third wall, and the fourth wall for indicating the inclination of the ladder stabiliser in two perpendicular directions.

Optionally, drainage holes are provided in the base.

Optionally, graspable handles are formed in, or attached to, at least the side walls to facilitate lifting and manoeuvring of the ladder stabiliser.

Further features and advantages of the present invention will become apparent from the claims and the following description.

Embodiments of the present invention will now be described, by way of example only, with reference to the following diagrams, in which:

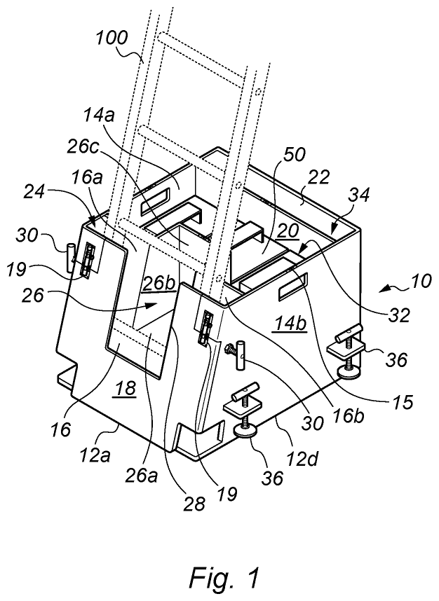

FIG. 1 is a schematic perspective view of a ladder stabiliser according to a first embodiment of the present invention with a ladder represented in phantom lines in-situ within its first open-topped three-dimensional space;

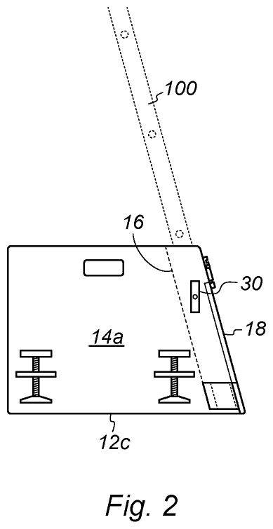

FIG. 2 is a schematic side view of the ladder stabiliser of FIG. 1;

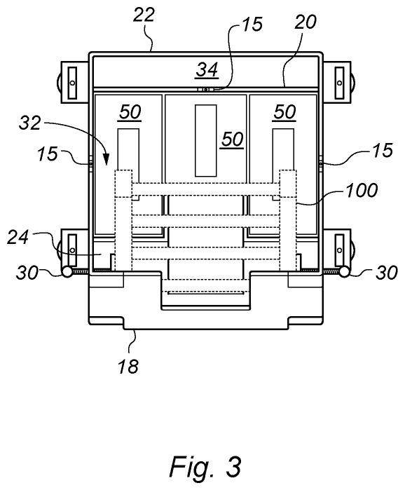

FIG. 3 is a schematic plan view of the ladder stabiliser of FIG. 1;

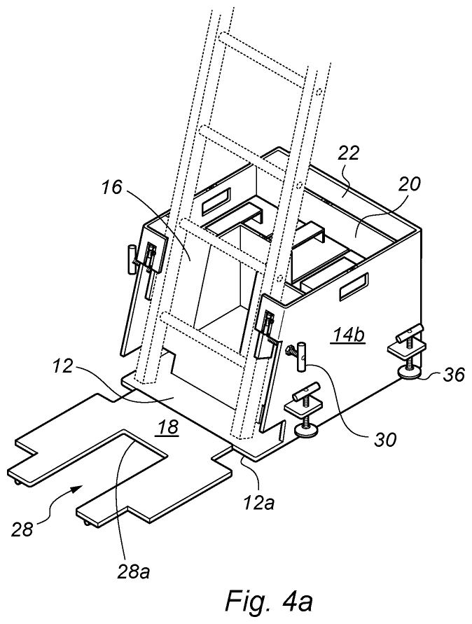

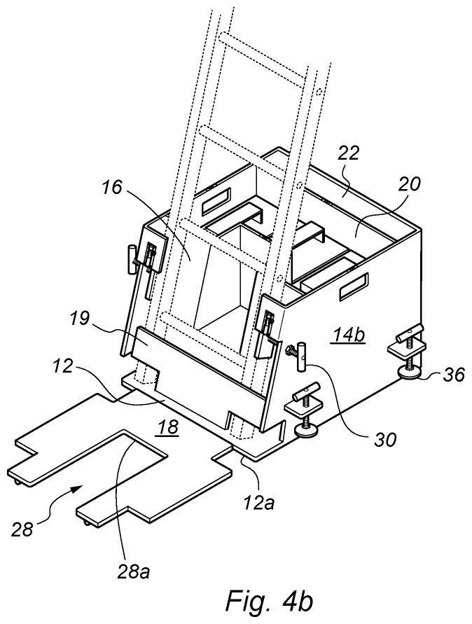

FIG. 4a is a schematic perspective view of the ladder stabiliser of FIG. 1 with its second wall in its open condition to facilitate insertion and removal of a ladder into the first three-dimensional space;

FIG. 4b is a schematic perspective view of a modified version of the ladder stabiliser of FIG. 4a comprising an adjustable bracing member for engaging the front surfaces of the lowermost ends of ladder stiles;

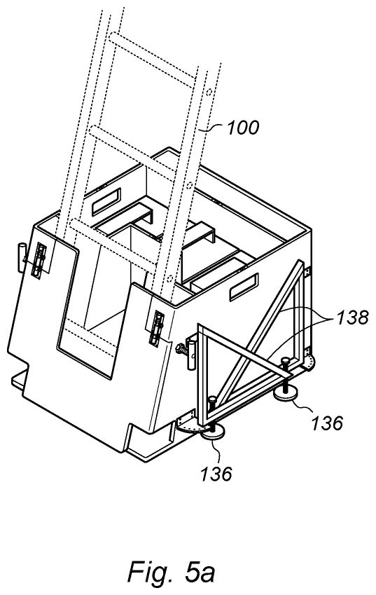

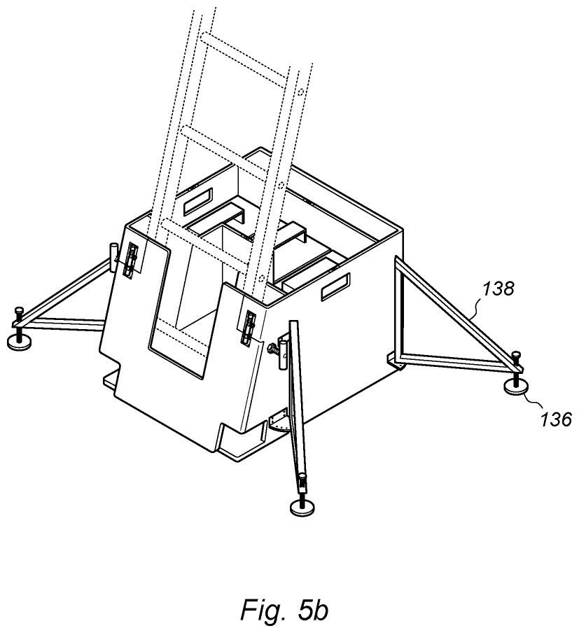

FIG. 5a is a schematic perspective view of a ladder stabiliser according to a second embodiment of the present invention showing its adjustable feet in their collapsed positions; and

FIG. 5b is a schematic perspective view of the ladder stabiliser of FIG. 5a showing its adjustable feet in their deployed positions.

As shown in FIG. 1, the ladder stabiliser of the present invention takes the form of a box-like structure 10 comprising: a planar, rectangular base 12 (see FIGS. 4a, 4b) having front, rear, and opposite side peripheral edges 12a-d; two planar side walls 14a, 14b extending vertically from the opposite side peripheral edges 12c, 12d of the base 12; a first planar wall 16 extending upwards from the base 12 at an inclined angle, and extending between the side walls 14a, 14b at a position proximate, but spaced from the front peripheral edge 12a; a second planar wall 18 pivotably attached to the base 12 at its front peripheral edge 12a, and extending between the side walls 14a, 14b; a third planar wall 20 extending vertically from the base 12, and extending between the side walls 14a, 14b at a position proximate, but spaced from and parallel to the rear peripheral edge 12b; and a fourth planar wall 22 extending vertically from the base 12 at its rear peripheral edge 12b, and extending between the side walls 14a, 14b.

The second wall 18 is pivotable between a fully open position (see FIG. 4a) in which it extends substantially parallel to the base 12; and a fully closed position (see FIG. 2) in which it extends at an inclined angle which is substantially equal to that of the first wall 16. A pair of locks 19 is provided for locking the second wall 18 in the closed position.

A first open-topped three-dimensional space 24 is defined between the internal surfaces of: the base 12, the first and second inclined walls 16, 18, and the vertical side wall portions 14a, 14b. The first and second walls 16, 18, and the side walls 14a, 14b each extend to a vertical height above the base 12. In a preferred embodiment the vertical height is at least 25 cm. It will be appreciated that this height will, in the vast majority of cases, be greater than the height of the first rung of a standard ladder 100 (shown in phantom lines) when arranged, in use, at its optimal angle of inclination. The first wall 16 is inclined at an angle of inclination relative to the base 12 which accords with the “1 in 4” gradient rule governing the optimal position for safe ladder use.

The first wall 16 is provided with a central recess 26 which causes its surface to adopt a general U-shape. The central recess 26 is provided with a base 26a, opposing side walls 26b, and a rear wall 26c. Inclined surface portions 16a, 16b are located at either side of the central recess 26. A central cut-out portion 28 is provided in the second wall 18, the side walls of which generally coincide and align with those of the central recess 26 formed in the first wall 16. The lowermost edge 28a of the central cut-out portion 28 may be arranged to be marginally lower than the base 26a of the central recess 26 within the first wall 16 to provide a degree of clearance for a user's foot as it is placed on, and removed from, the lowermost rung during use of the ladder 100.

A pair of laterally adjustable clamps 30 are attached to the opposing side wall portions 14a, 14b within the first three-dimensional space 24. In the alternative embodiment of FIG. 4b, a detachable and adjustable bracing member 19 is provided within the first open-topped three-dimensional space 24 proximate the base 12. The bracing member 19 is generally T-shaped to thereby match the outline shape of the lower part of the pivotable wall 18; and is inclined to match the angle of inclination of the first wall 16 and the pivotable wall 18. The bracing member 19 is securable to the inclined first wall 16. The spacing of the bracing member 19 from the inclined first wall 16 may be adjusted by, for example, screw threads (not shown) which extend through apertures (not shown) provided in the inclined first wall 16 and fastened behind it with wing nuts (not shown).

As best shown in FIG. 3, a second open-topped three-dimensional space 32 is defined between the internal surfaces of: the base 12, the first inclined wall 16, the third vertical wall 20, and vertical side wall portions 14a, 14b. A third open-topped three-dimensional space 34 is defined between the internal surfaces of: the base 12, the third and fourth vertical walls 20, 22, and vertical side wall portions 14a, 14b.

In the embodiments shown in FIGS. 1 to 4b there is provided four height-adjustable feet 36 proximate each lower corner of the box-like structure 10. The height-adjustable feet 36 are each attached to a side wall 14a, 14b at a position above its lowermost edge such that they may be vertically retracted and extended above and below the height of the base 12.

In the alternative embodiment of FIGS. 5a and 5b, the four height-adjustable feet 136 are attached to elongate triangular struts 138 which are pivotably deployable between: (i) a collapsed/folded position (see FIG. 5a) whereby they are arranged to overlap and lie substantially parallel to their respective side walls 14a, 14b; and (ii) an extended position (see FIG. 5b) whereby they are pivoted away from their respective side walls 14a, 14b.

In use, the ladder stabiliser 10 is positioned proximate a working site in accordance with the aforementioned “1 in 4” rule. Once manoeuvred into its approximate position, ballast weights 50 are introduced into the second open-topped three-dimensional space 32 to anchor the ladder stabiliser 10 in position. The user may then view the spirit levels provided at the upper edges of the side walls 14a, 14b and the third vertical wall 20 to determine whether the ladder stabiliser 10 is level on the ground. If not, appropriate adjustments are made to the height-adjustable feet 36 to level the ladder stabiliser 10. In the embodiment of FIGS. 5a and 5b, the triangular struts 138 are first deployed by pivoting them away from the respective side walls 14a, 14b before effecting any adjustments via the height-adjustable feet 136.

Once the ladder stabiliser 10 is anchored in position the locks 19 on its second wall 18 are disengaged and it is pivoted to open so as to lie in substantially the same plane as the base 12. The ladder stabiliser 10 is now ready to receive a ladder 100. Provided that there is sufficient space, a ladder 100 is positioned horizontally with its feet placed against, or proximate to, the first wall 16. The ladder 100 is then raised from its opposite end such that the lowermost ends of its stiles lie proximate to, or rest against, the inclined first wall 16; and the uppermost ends of its stiles lie against a supporting surface, e.g. a building wall. At this point the user should verify that the ladder stabiliser remains secure and level, and that the “1 in 4” spacing rule is being satisfied. If not, any necessary adjustments to the ladder length and/or positioning or levelling of the ladder stabiliser 10 can be made.

The second wall 18 is pivoted to its closed position and the locks 19 are re-engaged. The lowermost end of the ladder 100 is thereby enclosed within the first open-topped three-dimensional space 24 with its lowermost rung extending across the cut-out portion 28 formed within the second wall 18.

Finally, the clamps 30 are manually tightened against the two outer side surfaces of the ladder stiles within the first open-topped three-dimensional space 24. The ladder 100 may now be used safe in the knowledge that the first, second and side walls 16, 18, 14a, 14b, in combination with the clamps 30, will prevent the full range of unwanted ladder movements associated with “high fall” accidents, i.e. including lateral slippage of a ladder at its upper contact point, and flipping or pivoting of a ladder at its upper end each tend to cause one foot to disengage with the ground.

In the modified embodiment of FIG. 4b, the bracing member 19 may, if necessary, be attached and moved in the direction of the inclined first wall 16 to take up any free space between the pivotable wall 18 and the front surfaces of the ladder stiles. Once secured in place, the bracing member 19 provides additional support against unwanted ladder movement that may otherwise arise when, for example, smaller sized ladders 100 are used. The ladder stabiliser of the present invention is therefore entirely universal and suitable for use in any industry sectors and countries, irrespective of ladder types and dimensions.

A user may, by virtue of the central recess 26 and central cut-out portion 28, place his/her foot onto the lowermost ladder rung within the first open-topped three-dimensional space 24 and proceed to climb the ladder. When doing so, the rear surfaces of the ladder stiles are supported by the two lateral inclined portions of the first wall 16; the outside surfaces of the ladder stiles are supported by clamps 30; and significant movement of the ladder away from a supporting surface (such as a building wall) is prevented by the second wall 18. Accordingly, unwanted movement of the ladder is prevented, or at least significantly inhibited, in all directions.

Although particular embodiments of the invention have been disclosed herein in detail, this has been done by way of example and for the purposes of illustration only. The aforementioned embodiments are not intended to be limiting with respect to the scope of the appended claims. It is contemplated by the inventor that various substitutions, alterations, and modifications may be made to the invention without departing from the scope of the invention as defined by the claims.

Examples of these include, for example, drainage holes may be provided in the base 12 to allow the escape of rainwater. Graspable handles may be attached to or—as shown in the figures—formed in the side walls 14a, 14b to facilitate lifting and manoeuvring of the ladder stabiliser.

In order to accommodate certain types of ladders having enlarged foot portions extending perpendicularly with respect to the stiles, suitable sized apertures may be formed proximate the lower corners of the first and second walls 16, 18 and the side walls 14a, 14b, as illustrated in the figures. This will ensure that the ladder stabiliser 10 is able to accept different foot structures.

In order to accommodate ladders having different stile thicknesses, the ladder stabiliser 10 may be provided with a set of spacers (not shown) which can be introduced into the first open-topped three-dimensional space 24 to fill any gaps in front of and/or behind the stiles. This will ensure that the ladder stabiliser 10 is able to secure all ladders against unwanted movement in a direction perpendicular to the plane of the first wall 16 irrespective of stile thickness. The spacers may be stored inside the third open-topped three-dimensional space 34 when not in use.

In one embodiment (not shown), a strap and buckle arrangement is attached to the first wall 16 proximate the likely position of the lowermost rung of the ladder 100. This may be used to secure the lowermost rung and prevent it from “kicking up” should it become top heavy as it is raised into position against a supporting surface.

Finally, full opening of the second wall may be inhibited by the presence of the locks 19 on the outside of the second wall 18. This may impede the process of positioning a ladder 100 into the ladder stabiliser 10. Accordingly, in addition to the height adjustable feet 36, 136 shown in the figures, further fixed feet (not shown) may be provided on the underside of the base 12 for the purpose of raising the base above the ground by a distance which is at least equal to the depth distance of the locks 19. This will ensure that the second wall 18 can always be opened to be at least parallel with the base 12.

1. A ladder stabiliser comprising:
(i) a base for supporting, in use, both feet of a ladder; and
(ii) at least two walls extending upwards from the base and defining, with the base, a first open-topped three-dimensional space for accommodating, and at least partially enclosing, the lower distal ends of a ladder, said three-dimensional space being defined, at least in part, by a substantially planar first wall extending upwards from the base;
wherein at least part of said at least one wall extends to a height above the base which, in use, is equal to, or greater than, that of the lowermost rung of an inclined ladder; and wherein the first wall is inclined at an angle of inclination with respect to the base for providing support, in use, to the rear surfaces of ladder stiles located within the first three-dimensional space.

2. A ladder stabiliser according to claim 1, wherein said first three-dimensional space is defined, at least in part, by substantially planar spaced apart side walls each extending upwards from the base.

3. (canceled)

4. A ladder stabiliser according to claim 1, wherein the first wall extends between substantially planar spaced apart side walls each extending upwards from the base.

5. (canceled)

6. A ladder stabiliser according to claim 1, wherein the angle of inclination of the first wall relative to the base is between 75 degrees and 77 degrees.

7. A ladder stabiliser according to claim 6, wherein the angle of inclination of the first wall relative to the base is 75.96 degrees.

8. A ladder stabiliser according to claim 1, wherein a pair of laterally adjustable clamps are arranged within the first three-dimensional space for selectively engaging, in use, respective outer lateral side surfaces of ladder stiles.

9. A ladder stabiliser according to claim 8, wherein the laterally adjustable clamps are attached to opposing side walls of the first three-dimensional space.

10. A ladder stabiliser according to claim 1, wherein said first three-dimensional space is defined, at least in part, by a substantially planar second wall extending upwards from the base.

11. A ladder stabiliser according to claim 10, wherein the second wall is spaced from the first wall and extends between spaced apart side walls extending upwards from the base.

12. A ladder stabiliser according to claim 10, wherein at least one of the respective side walls, the first wall and the second wall extends to a height above the base which is greater, in use, than that of the lowermost rung of an inclined ladder.

13. A ladder stabiliser according to claim 10, wherein the second wall has a hinged connection with the base and is moveable between an open and closed positions.

14. A ladder stabiliser according to claim 10, wherein the second wall has a hinged connection with one of the side walls and is moveable between open and closed positions.

15. A ladder stabiliser according to claim 13, wherein a lock is provided for selectively securing the second wall in the closed position.

16. A ladder stabiliser according to claim 10, wherein a central recessed portion is formed in the first wall.

17. A ladder stabiliser according to claim 16, wherein the central recessed portion is provided with a base, opposing side walls and a rear wall.

18. A ladder stabiliser according to claim 16, wherein a central cut-out portion is provided on the second wall to generally coincide with the central recessed portion formed in the first wall.

19. A ladder stabiliser according to claim 10, wherein a substantially planar third wall extends upwards from the base.

20. A ladder stabiliser according to claim 19, wherein the third wall is spaced from the first wall and extends between the spaced apart side walls.

21. A ladder stabiliser according to claim 19, wherein a second open-topped three-dimensional space is defined by the spaced apart first and third walls, and the spaced apart side walls.

22. A ladder stabiliser according to claim 21, wherein at least one removable ballast weight is receivable within the second three-dimensional space.

23. A ladder stabiliser according to claim 1, wherein height-adjustable feet are connected to the base and/or wall for levelling the ladder stabiliser before use.

24. A ladder stabiliser according to claim 23, wherein the height-adjustable feet are located at fixed positions proximate each corner of the base and/or side walls.

25. (canceled)

26. A ladder stabiliser according to claim 19, wherein a fourth wall is spaced from the third wall and extends between the spaced apart side walls to define a third open-topped three-dimensional space.

27. A ladder stabiliser according to claim 26, wherein at least two spirit levels are provided on at least two of the respective side walls, the first wall, the second wall, the third wall, and the fourth wall for indicating the inclination of the ladder stabiliser in two perpendicular directions.

28. (canceled)

29. (canceled)
